(19) United States
(12) Patent Application Publication
(10) Pub. No.: US 2009/0302253 A1
(43) Pub. Date: Dec. 10, 2009

(54) CYROGENIC VALVE

(75) Inventor: Kyung-Wan Ko, Gyeongsangnam-do (KR)

Correspondence Address: Workman Nydegger;1000 Eagle Gate Tower, 60 East South Temple, Salt Lake City, UT, 84111, US

(73) Assignee: Jokwang I.L.I Co., Ltd., Busan (KR)

(21) Appl. No.: 12/197,825

(22) Filed: Aug. 25, 2008

(30) Foreign Application Priority Data
Jun. 5, 2008 (KR) 10-2008-0053384

(51) Int. Cl. F16K 31/44; F16K 25/00

(52) U.S. Cl. 251/213; 251/359; 251/368

(57) ABSTRACT

A cryogenic valve includes a main body which has an opening, a bonnet which is coupled to the main body, a disc which opens or closes the opening, a stem which is placed through the bonnet, and a drive unit which actuates the disc and the stem. A first seat is provided at the position at which the disc comes into contact with the opening, and a second seat is provided at the position at which the disc comes into contact with the bonnet, so that either when the valve is closed or when the valve is completely open, fluid is prevented from being drawn into the bonnet, thus making it possible to replace a packing with a new one even when the system is in operation.

### CROSS-REFERENCE TO RELATED APPLICATIONS

This application claims priority to Korean Application Serial No. 10-2008-0053384, filed Jun. 5, 2008, which is incorporated herewith by specific reference.

### BACKGROUND OF THE INVENTION

1. The Field of the Invention

The present invention relates generally to cryogenic valves and, more particularly, to a cryogenic valve, which includes a main body, which has an opening therein, a bonnet, which is coupled to the main body, a disc, which is provided in the main body and moves between the opening and the bonnet to open or close the opening, a stem, which is coupled to the disc and is placed through the bonnet, and a drive unit, which actuates the disc and the stem to control fluid that flows through the main body, wherein a first seat is provided at a position, at which the disc comes into contact with the opening, and a second seat is provided at a position, at which the disc comes into contact with the bonnet, so that when the disc is moved upwards and the valve is completely open as well as when the disc is moved downwards and the valve is closed, airtightness is ensured such that fluid is prevented from being drawn into the bonnet, thus making it possible to replace a packing with a new one even when the system is in operation, wherein the second seat may have a shape corresponding to that of the upper end of the disc, so that, even when the disc comes into contact with the second seat to completely open the valve, the airtightness can be reliably ensured, the second seat may be formed into the same shape as that of the first seat, so that one kind of seat can be used as both the first seat and the second seat, the second seat may be made of stainless steel to enhance the durability thereof, and the bonnet may have on the circumferential outer surface thereof a vertical reinforcing fin, which extends in the longitudinal direction of the bonnet, so that the thickness of the bonnet can be reduced, and the bonnet and the vertical reinforcing fin can be integrally formed, thus enhancing production efficiency.

2. The Relevant Technology

Generally, cryogenic valves are devices, which are used in LNG carriers or the aerospace industry, and are specially designed such that they can be used in cryogenic conditions. In other words, elements constituting the cryogenic valves must meet conditions that sufficient toughness is ensured at cryogenic temperature, weldability and workability are superior, and corrosion resistance to fluid is ensured. Furthermore, parts that open and valve bodies must be able to ensure the airtightness at cryogenic temperature. In addition, drive units must be thermally isolated at cryogenic temperatures to ensure the normal operation thereof.

FIG. 1 is a sectional view showing a conventional cryogenic valve. FIG. 2 is an enlarged view of a circled portion ‘A’ of FIG. 1.

Referring to FIGS. 1 and 2, the conventional cryogenic valve includes a main body 1, which has an opening 11 therein, a bonnet 2, which is coupled to the main body 1, a disc 3, which is provided in the main body 1 to open or close the opening 11, and a stem 4, which is coupled to the disc 3 and is placed through the bonnet 2. The cryogenic valve further includes a positioner 6, an actuator 7 and a handle 8 which control movement of the stem 4 and the disc 3. A seat 12 is provided in the main body 1 at the position where the disc 3 comes into contact with the opening 11.

When pneumatic pressure is applied to the actuator 7 by an electric signal of the positioner 6, the distance that the stem 4 and the disc 3 are lifted is determined in a predetermined proportion such as, for example, 0%, 25%, 50%, 75% or 100%, depending on the electric signal. In this structure, because the stem 4 is frequently moved, a packing 22, which is provided at the junction between the bonnet 2 and the yoke 5 to ensure the airtightness such that fluid is prevented from being drawn into the yoke 5, becomes easily worn. Therefore, work of replacing the packing 22 with a new one must be periodically conducted.

Here, in consideration of the very low temperature of the fluid and the possibility of explosion, the replacement work must be conducted in a state in which the fluid is reliably prevented from leaking through a gap 24 between the bonnet 2 and the stem 4 (in the direction of c). For this, after the disc 3 is completely moved downwards (in the direction of \textcircled{1}) such that the disc 3 is brought into close contact with the seat 12, that is, such that the valve enters the closed state and a system thus enters the stopped state, the replacement work must be conducted at a separate predetermined point in time. In other words, there is a disadvantage in that it is impossible to replace the packing 22 with a new one when the system is in operation, and the replacement work must be conducted after the system is stopped.

Furthermore, in the conventional technique, fins 23 are provided on the circumferential outer surface of the bonnet 2 and are oriented in the directions perpendicular to the longitudinal direction of the bonnet 2. That is, each fin 23 has a flange shape, which extends in the horizontal direction. However, in this case, there is a problem in that it is difficult to integrally form the bonnet 2 and the fins 23 through a single process.

### SUMMARY OF THE INVENTION

Accordingly, the present invention has been made keeping in mind the above problems occurring in the prior art, and an object of the present invention is to provide a cryogenic valve, which includes a main body, which has an opening therein, a bonnet, which is coupled to the main body, a disc, which is provided in the main body and moves between the opening and the bonnet to open or close the opening, a stem, which is coupled to the disc and is placed through the bonnet, and a drive unit, which actuates the disc and the stem to control fluid that flows through the main body, wherein a first seat is provided at a position, at which the disc comes into contact with the opening, and a second seat is provided at a position, at which the disc comes into contact with the bonnet, so that when the disc is moved upwards and the valve is completely open as well as when the disc is moved downwards and the valve is thus closed, the airtightness is ensured such that fluid is prevented from being drawn into the bonnet, so that, even when a system is in operation, it is possible to replace a packing with a new one.

Another object of the present invention is to provide a cryogenic valve, in which the second seat has a shape corresponding to that of the upper end of the disc, so that, even when the disc comes into contact with the second seat to completely open the valve, the airtightness can be reliably ensured.

A further object of the present invention is to provide a cryogenic valve, in which the second seat is formed into the same shape as that of the first seat, so that one kind of seat can be used as both the first seat and the second seat, thus enhancing production efficiency.

Yet another object of the present invention is to provide a cryogenic valve, in which the second seat is made of stainless steel, so that corrosion resistance to cryogenic fluid is ensured, and the workability is increased.

Still another object of the present invention is to provide a cryogenic valve, in which a vertical reinforcing fin, which extends in the longitudinal direction of the bonnet, is provided on the circumferential outer surface of the bonnet, so that the thickness of the bonnet can be reduced, and the bonnet and the vertical reinforcing fin can be integrally formed, thus enhancing the production efficiency.

In order to accomplish the above objects, the present invention has the following construction.

According to an embodiment, the present invention provides a cryogenic valve, including: a main body, having an opening therein; a bonnet coupled to the main body; a disc provided in the main body, the disc moving between the opening and the bonnet to open or close the opening; a stem coupled to the disc, the stem being placed through the bonnet; and a drive unit for actuating the disc and the stem to control fluid that flows through the main body. A first seat is provided at a position at which the disc comes into contact with the opening, and a second seat is provided at a position at which the disc comes into contact with the bonnet. Therefore, when the disc is moved downwards and the valve is closed and also when the disc is moved upwards and the valve is completely open, airtightness is ensured such that fluid is prevented from being drawn into the bonnet, so that, when a system is in operation, a packing is replaceable with a new one.

According to another embodiment, in the cryogenic valve of the present invention, the second seat may have a shape corresponding to a shape of an upper end of the disc. Hence, even when the disc comes into contact with the second seat to completely open the valve, the airtightness can be ensured.

According to another embodiment, in the cryogenic valve of the present invention, the second seat may have a shape equal to a shape of the first seat. Accordingly, one kind of seat can be used as both the first seat and the second seat.

According to another embodiment, in the cryogenic valve of the present invention, the second seat may be made of stainless steel to increase durability thereof

According to another embodiment, in the cryogenic valve of the present invention, the bonnet may have on a circumferential outer surface thereof a vertical reinforcing fin extending in a longitudinal direction of the bonnet. Therefore, the thickness of the bonnet can be reduced, and the bonnet and the vertical reinforcing fin may be integrally formed, thus enhancing production efficiency.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a sectional view showing a conventional cryogenic valve;

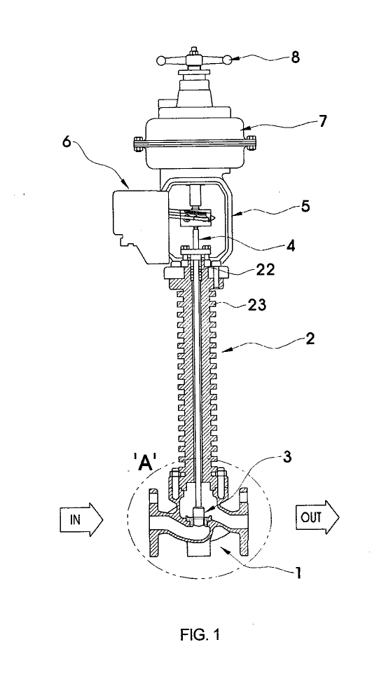

FIG. 2 is an enlarged view of a circled portion ‘A’ of FIG. 1;

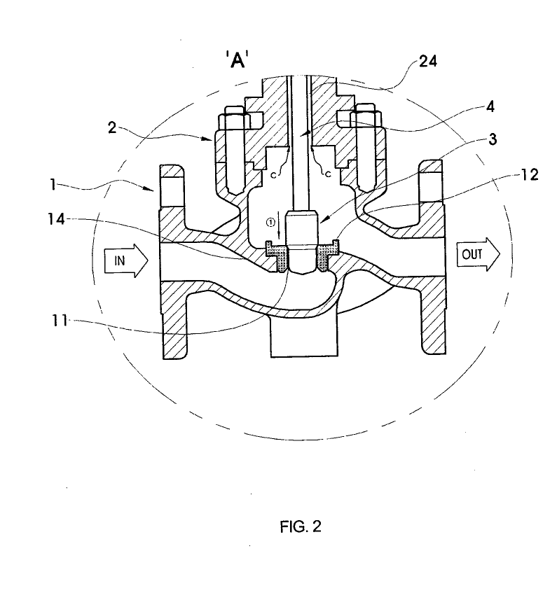

FIG. 3 is a perspective view illustrating a cryogenic valve, according to a first embodiment of the present invention;

FIG. 4 is a sectional view illustrating the cryogenic valve according to the first embodiment of the present invention;

FIG. 5 is an enlarged view illustrating a main body of the cryogenic valve of FIG. 4 when in a closed state;

FIG. 6 is an enlarged view illustrating the main body of the cryogenic valve of FIG. 4 when in a completely open state; and

FIG. 7 is a perspective view illustrating a cryogenic valve according to a second embodiment of the present invention.

### DETAILED DESCRIPTION OF THE PREFERRED EMBODIMENTS

Hereinafter, preferred embodiments of the present invention will be described in detail with reference to the attached drawings.

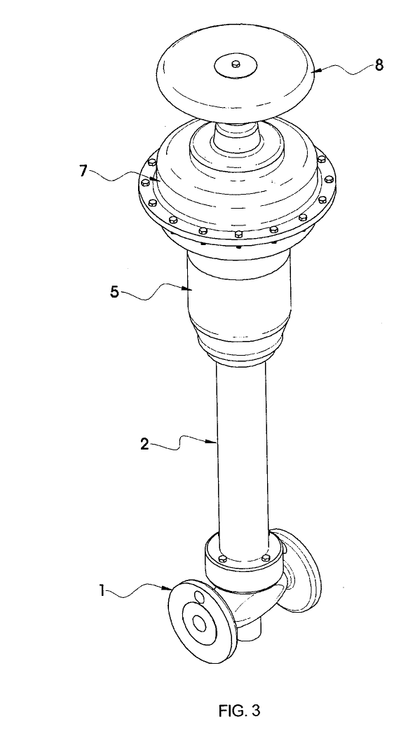

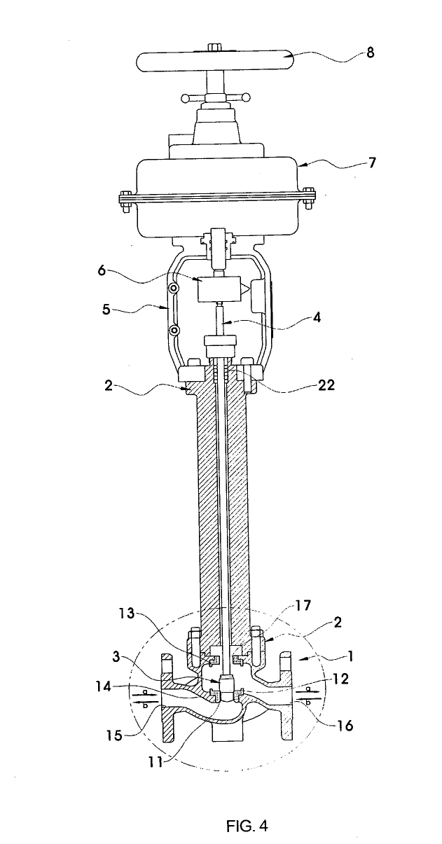

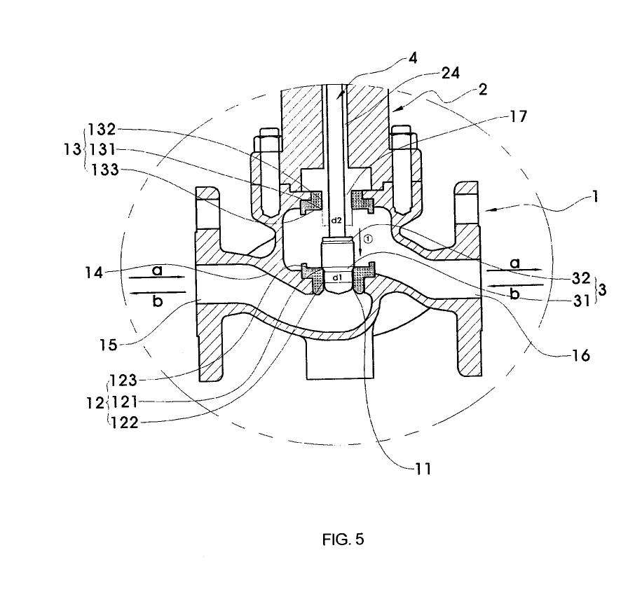

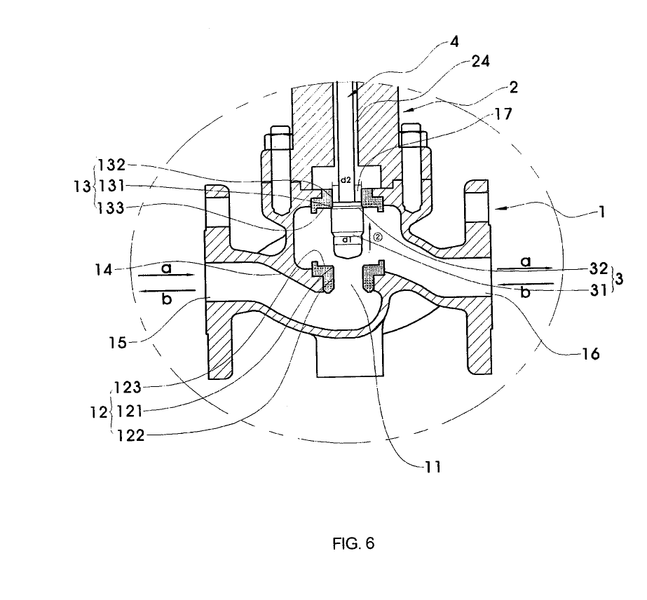

FIG. 3 is a perspective view illustrating a cryogenic valve, according to a first embodiment of the present invention. FIG. 4 is a sectional view illustrating the cryogenic valve according to the first embodiment of the present invention. FIG. 5 is an enlarged view illustrating a main body of the cryogenic valve of FIG. 4 when in a closed state. FIG. 6 is an enlarged view illustrating the main body of the cryogenic valve of FIG. 4 when in a completely open state.

Referring to FIGS. 3 through 6, the cryogenic valve according to the first embodiment of the present invention includes the main body 1, which has an opening 11 therein, a bonnet 2, which is coupled to the main body 1, and a disc 3, which is provided in the main body 1 and moves between the opening 11 and the bonnet 2 to open or close the opening 11. The cryogenic valve further includes a stem 4, which is coupled to the disc 3 and is placed through the bonnet 2, and a drive unit, which actuates the disc 3 and the stem 4 to control fluid, which flows through the main body 1. Furthermore, in the cryogenic valve, a first seat 12 is provided at the position at which the disc 3 comes into contact with the opening 11. A second seat 13 is provided at the position at which the disc 3 comes into contact with the bonnet 2. Here, the “drive unit” means a mechanism to control the operation of the disc 3 and the stem 4 and typically has a meaning including a yoke 5, a positioner 6, an actuator 7 and a handle 8.

The main body 1 is a valve body, through which cryogenic fluid flows. Typically, in the case of a globe valve such as the valve of the present invention, the main body has a ball shape. A center axis of an inlet 15, into which fluid is drawn, and a center axis of an outlet 16, through which fluid is discharged, are placed in a straight line. A partition wall 14 is provided in the main body 1. The opening 11 is formed at a central portion through the partition wall 14. Thus, the flow of fluid forms an S shape. The main body 1 that is used in the cryogenic valve according to the first embodiment of the present invention also has the same structure as that of a typical globe valve.

In this structure, when the disc 3, which will be explained in detail later herein, is seated onto the first seat 12 of the opening 1 1, the flow of fluid is interrupted. Furthermore, depending on a distance, by which the disc 3 is spaced apart from the opening 1 1, the flow rate of fluid is varied. In other words, depending on whether the disc 3 moves upwards (in the direction of \textcircled{2}) or downwards (in the direction of \textcircled{2}), that is, depending on whether the valve is actuated in an opening direction or in a closing direction, the flow rate and the pressure of fluid can be controlled. Therefore, it is very important to ensure airtightness when the disc 3 comes into contact with the first seat 12 of the opening 11. Furthermore, the flow of fluid in the main body 1 is classified into the case where fluid flows from the left to the right (in the direction of a), that is, the case where fluid is drawn into the inlet 15 and is discharged outside through the outlet 16 after passing through the opening 11 upwards, and the case where fluid flows from the right to the left (in the direction of b), that is, the case where fluid is drawn into the outlet 16 and is discharged outside through the inlet 15 after passing through the opening 11 downwards. The cryogenic valve of the present invention is advantageous in that it can be used in both the above two cases.

The bonnet 2 is connected to the upper end of the main body 1 and serves to couple the main body 1 to the drive unit. The bonnet 2 has a hollow rod shape having an internal space. A stem 4, which is connected to the disc 3, is placed through the internal space in the bonnet 2.

In this case, fluid that flows through the main body 1 is drawn into the bonnet 2. Here, because fluid that flows through the main body 1 is at a cryogenic temperature and the drive unit is operated at room temperature, cryogenic fluid must be prevented from affecting the drive unit. As the length of the bonnet 2 is increased, fluid can increase in temperature due to heat exchange with the outside while the fluid flows through the bonnet 2. In addition, if fins are additionally provided on the outer surface of the bonnet 2, the temperature of fluid can be further increased while flowing through the bonnet 2. As such, the bonnet 2 serves to isolate the drive unit from cryogenic fluid such that the drive unit can be normally operated. Meanwhile, a packing 22 is provided at the junction between the bonnet 2 and the drive unit to prevent fluid from penetrating the drive unit. As described above, because the stem 4 is frequently moved when the valve is opened or closed, the packing 22 becomes worn. Therefore, it is preferable that the packing 22 be periodically replaced with a new one.

The disc 3 is connected to the stem 4, which will be described later herein, and is moved in the main body 1 between the opening 11 and the bonnet 2 to open or close the opening 11 under the control of the drive unit. The disc 3 has a cylindrical shape overall. The lower end of the disc 3 has a shape corresponding to the shape of the inner surface of the first seat 12, which will be explained later herein. In detail, the lower end of the disc 3 has a first inclined surface 31, which is inclined inwards and downwards from the circumferential outer surface of the cylindrical body such that the diameter thereof is reduced. The diameter d1 of the reduced-diameter part of the lower end of the disc 3 is the same as the inner diameter of the first seat 12. The first inclined surface 31 comes into contact with an inclined surface 121 of the first seat 12 which will be explained later herein. Thus, when the disc 3 is moved downwards (in the direction of \textcircled{1}), the lower end of the disc 3 is brought into close contact with the first seat 12, thus ensuring the airtightness. The upper end of the disc 3 has a shape corresponding to the shape of the inner surface of the second seat 13 which will be later herein. In detail, the upper end of the disc 3 has a second inclined surface 32, which is inclined inwards and upwards from the circumferential outer surface of the cylindrical body such that the diameter thereof is reduced. The diameter d2 of the reduced-diameter part of the upper end of the disc 3 is the same as the inner diameter of the second seat 13. The second inclined surface 32 comes into contact with an inclined surface 131 of the second seat 13 which will be explained later herein. Thus, when the disc 3 is completely moved upwards (in the direction of \textcircled{2}), the upper end of the disc 3 is brought into close contact with the second seat 13, thus ensuring the airtightness. Here, in the case where the first seat 12 has the same shape as that of the second seat 13, the first inclined surface 31 also has the same shape as that of the second inclined surface 32, and the diameters d1 and d2 are also the same as each other.

Depending on a distance, by which the disc 3 is spaced apart from the opening 11, and the shape of the lower end of the disc 3, a flow rate and a flow pressure of fluid are determined. In particular, according to the shape of the lower end of the disc 3, the control types of the valve are classified into a linear flow type, in which a flow rate of fluid is controlled such that it is changed in direct proportion to the distance that the disc 3 moves, an equal percentage flow type, in which a change in flow rate is proportionally small compared to the distance that the disc moves, and a quick opening flow type, in which a change in flow rate is proportionally large relative to the distance that the disc moves. The cryogenic valve of the present invention can be applied to the all types.

The stem 4 is connected to the disc 3 and serves to move the disc 3 under the control of the drive unit. The stem 4 has a rod shape overall. The stem 4 is connected at the lower end thereof to the disc 3 and is connected at the upper end thereof to the drive unit.

The stem 4 is moved upwards or downwards under the control of the drive unit. Here, due to such movement of the stem 4, the packing 22, which is provided between the bonnet 2 and the drive unit to ensure the airtightness, becomes worn. Therefore, it is necessary to periodically replace the packing 22 with a new one.

The “drive unit” means a mechanism to control the operation of the disc 3 and the stem 4, as described above. Typically, the drive unit includes the yoke 5, the positioner 6, the actuator 7 and the handle 8.

The first seat 12 is disposed in the main body 1 at a position, at which the disc 3 comes into contact with the opening 11. Preferably, the first seat 12 may be coupled to the partition wall 14 in a bolt coupling manner. The first seat 12 has a hollow shape overall. The outer surface of the first seat 12 has a shape corresponding to that of the opening 11, and the inner surface thereof has a shape corresponding to that of the disc 3. In detail, the inclined surface 121 is formed on the junction between an upper surface 123 and an inner surface 122 of the first seat 12. The inclined surface 121 has the same shape as that of the first inclined surface 31 of the disc 3. The inner diameter of the inner surface 122 of the first seat 12 is the same as the diameter d1 of the circumferential outer surface of the reduced-diameter part of the lower end of the disc 3.

As such, because the inner surface 122 of the first seat 12 has the shape corresponding to that of the lower end of the disc 3 and has the same diameter as that of the lower end of the disc 3, when the disc 3 moves downwards (in the direction of \textcircled{1}) under the control of the drive unit and thus closes the opening 11, the disc 3 can come into close contact with the first seat 12, thus ensuring the airtightness such that fluid can be reliably prevented from leaking out through the opening 11. Furthermore, in consideration of contact with cryogenic fluid, the first seat 12 is preferably made of stainless steel which has corrosion resistance to cryogenic fluid and high workability.

The second seat 13 is disposed in a portion 17, at which the main body 1 and the bonnet 2 contact each other, and through which the stem 4 is placed, at a position, at which the disc 3 comes into contact with the portion 17. The second seat 13 may be coupled to the main body 1 or the bonnet 2 in a bolt coupling manner. The second seat 13 has a hollow shape. The outer surface of the second seat 13 has a shape corresponding to the shape of the portion 17, through which the stem 4 is placed, and the inner surface thereof has a shape corresponding to the shape of the upper end of the disc 3. In detail, the inclined surface 131 is formed on the junction between an upper surface 133 and an inner surface 132 of the second seat 13. The inclined surface 131 has the same shape as that of the second inclined surface 32 of the disc 3. The inner diameter of the inner surface 132 of the second seat 13 is the same as the diameter d2 of the circumferential outer surface of the reduced-diameter part of the upper end of the disc 3.

As such, because the inner surface 132 of the second seat 13 has the shape corresponding to that of the upper end of the disc 3, when the disc 3 moves upwards (in the direction of \textcircled{2}) under the control of the drive unit and thus closes the portion 17, through which the stem 4 is placed, the disc 3 can come into close contact with the second seat 13, thus ensuring the airtightness such that fluid can be reliably prevented from being drawn into the bonnet 2. Therefore, when a process of replacing the packing 22, which requires periodical replacement with a new one due to abrasion, is conducted, in the case of the conventional techniques, the replacement process must be conducted in the state in which the valve is closed, that is, the disc 3 closes the opening 11. In other words, the system must be stopped during the replacement process. However, in the present invention, even when the valve is in the open state, the disc 3 is in the state in which it is in close contact with the second seat 13, so that the airtightness can be reliably ensured by the second seat 13, thus preventing fluid from being drawn into the bonnet 2. Hence, the replacement of the packing 22 can be conducted even without stopping the system.

Furthermore, the second seat 13 may have the same shape and diameter as those of the first seat 12. In this case, because the first seat 12 and the second seat 13 are compatible with each other, only one kind of seat can be manufactured and used as both the first seat 12 and the second seat 13, thus increasing production efficiency, and reducing production costs.

In the same manner as the first seat 12, in consideration of contact with cryogenic fluid, the second seat 13 is preferably made of stainless steel. In this case, the second seat 13 can have corrosion resistance to cryogenic fluid and high workability, thus enhancing the durability of the cryogenic valve.

As well, because the second seat 13 is constructed such that it is installed in the portion 17, through which the stem 4 is placed, the second seat 13 can also serve to guide the movement of the stem 4.

As described above, the cryogenic valve according to the first embodiment of the present invention includes the second seat 13, so that, as well as when the disc 3 is moved downwards (in the direction of \textcircled{1}) and the valve is thus closed, even when the disc 3 is moved upwards (in the direction of \textcircled{2}) and the valve is thus completely open, fluid is prevented from being drawn into the bonnet 2, in other words, the airtightness is ensured. Therefore, even when the system is in operation, work of replacing the packing 22 with a new one can be conducted. Furthermore, because the second seat 13 has the shape corresponding to that of the upper end of the disc 3, when the disc 3 comes into contact with the second seat 13 to completely open the valve, the airtightness can be reliably ensured. In addition, the second seat 13 may be manufactured into the same shape as that the first seat 12, such that one kind of seat can be used as both the first seat 12 and the second seat 13. Moreover, the second seat 13 is made of stainless steel, so that the durability of the cryogenic valve can be enhanced.

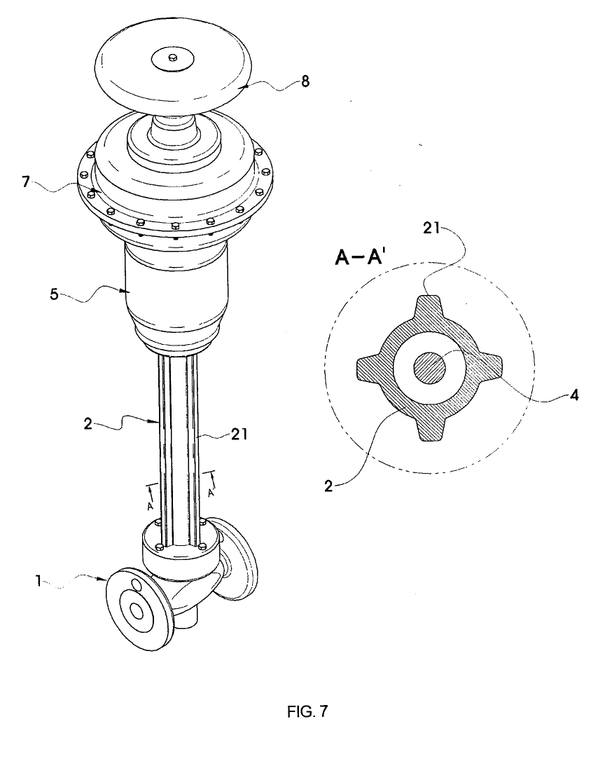

FIG. 7 is a perspective view illustrating a cryogenic valve according to a second embodiment of the present invention.

Referring to FIG. 7, the cryogenic valve according to the second embodiment of the present invention is characterized in that a vertical reinforcing fin 21 is longitudinally provided on the circumferential outer surface of a bonnet 2.

The vertical reinforcing fin 21, which is provided on the circumferential outer surface of the bonnet 2, extends in a vertical direction, that is, in the longitudinal direction of the bonnet 2. Preferably, a plurality of vertical reinforcing fins 21 may be provided on the circumferential outer surface of the bonnet 2.

As stated above, fluid that flows through the main body 1 is drawn into the bonnet 2. Here, because fluid that flows through the main body 1 is at a cryogenic temperature and the drive unit is operated at room temperature, cryogenic fluid must be prevented from affecting the drive unit. In the second embodiment, as well as having a relatively long length, the bonnet 2 has the vertical reinforcing fins 21 on the circumferential outer surface thereof Therefore, when fluid flows through the bonnet 2, the temperature of the fluid sufficiently increases due to heat exchange with the outside. As such, the bonnet 2 can satisfactorily conduct a function of isolating the drive unit from cryogenic fluid such that the drive unit can be normally operated. To further enhance the effect of increasing the temperature of fluid, each vertical reinforcing fin 21 preferably has a trapezoidal or triangular cross-section. If the end of the vertical reinforcing fin 21 is acute, the effect of increasing the temperature of fluid is further enhanced. Furthermore, though the effect of increasing the temperature of fluid is increased, the bonnet 2 can be reduced in thickness.

In the case of the conventional art, because the fins 23 are provided on the circumferential outer surface of the bonnet 2 in horizontal directions, that is, in the directions perpendicular to the longitudinal direction of the bonnet 2, it is difficult to integrally form the fins 23 with the bonnet 2, as described above. However, in the present invention, the vertical reinforcing fins 21 can be easily integrally formed with the bonnet 2 through an injection or extrusion process. Furthermore, because the thickness of the bonnet 2 can be reduced, the productivity is enhanced.

As such, in the cryogenic valve according to the second embodiment of the present invention, the vertical reinforcing fins 21 are longitudinally provided on the circumferential outer surface of the bonnet 2, so that the thickness of the bonnet 2 can be reduced, and the bonnet 2 and the vertical reinforcing fins 21 can be integrally formed, thus enhancing production efficiency.

As described above, the present invention provides a cryogenic valve, which includes a main body, which has an opening therein, a bonnet, which is coupled to the main body, a disc, which is provided in the main body and moves between the opening and the bonnet to open or close the opening, a stem, which is coupled to the disc and is placed through the bonnet, and a drive unit, which actuates the disc and the stem to control fluid that flows through the main body. Furthermore, a first seat is provided at the position at which the disc comes into contact with the opening. A second seat is provided at the position at which the disc comes into contact with the bonnet. Therefore, when the disc is moved downwards and the valve is closed and also when the disc is moved upwards and the valve is completely open, the airtightness is ensured such that fluid is prevented from being drawn into the bonnet. Thus, even when the system is in operation, work of replacing a packing with a new one can be conducted.

Furthermore, in the cryogenic valve according to the present invention, the second seat has a shape corresponding to that of the upper end of the disc, so that, even when the disc comes into contact with the second seat to completely open the valve, the airtightness can be reliably ensured.

In addition, the second seat may be formed into the same shape as that of the first seat. In this case, one kind of seat can be used as both the first seat and the second seat. Hence, production efficiency can be enhanced.

As well, the second seat is made of stainless steel, so that corrosion resistance to cryogenic fluid is ensured, and the workability of the second seat is increased.

Moreover, in the cryogenic valve according to the present invention, a vertical reinforcing fin may be longitudinally provided on the circumferential outer surface of the bonnet. In this case, there are advantages in that the thickness of the bonnet can be reduced, and the bonnet and the vertical reinforcing fins can be integrally formed, thus enhancing the production efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A cryogenic valve, comprising:
a main body, having an opening therein;
a bonnet coupled to the main body;
a disc provided in the main body, the disc moving between the opening and the bonnet to open or close the opening;
a stem coupled to the disc, the stem being placed through the bonnet; and
a drive unit for actuating the disc and the stem to control fluid that flows through the main body;
wherein a first seat is provided at a position at which the disc comes into contact with the opening, and a second seat is provided at a position at which the disc comes into contact with the bonnet, so that when the disc is moved downwards and the valve is closed, or when the disc is moved upwards and the valve is completely open, airtightness is ensured such that fluid is prevented from being drawn into the bonnet, so that, when a system is in operation, a packing is replaceable with a new one.

2. The cryogenic valve as set forth in claim 1, wherein the second seat has a shape corresponding to a shape of an upper end of the disc, so that, when the disc comes into contact with the second seat to completely open the valve, the airtightness is ensured.

3. The cryogenic valve as set forth in claim 1, wherein the second seat has a shape equal to a shape of the first seat, so that one kind of seat is used as both the first seat and the second seat.

4. The cryogenic valve as set forth in claim 1, wherein the second seat is made of stainless steel to increase durability thereof.

5. The cryogenic valve as set forth in claim 2, wherein the second seat is made of stainless steel to increase durability thereof.

6. The cryogenic valve as set forth in claim 3, wherein the second seat is made of stainless steel to increase durability thereof.

7. The cryogenic valve as set forth in claim 1, wherein the bonnet has on a circumferential outer surface thereof a vertical reinforcing fin extending in a longitudinal direction of the bonnet, so that a thickness of the bonnet is reducible, and the bonnet and the vertical reinforcing fin are integrally formed, thus enhancing production efficiency.

8. The cryogenic valve as set forth in claim 2, wherein the bonnet has on a circumferential outer surface thereof a vertical reinforcing fin extending in a longitudinal direction of the bonnet, so that a thickness of the bonnet is reducible, and the bonnet and the vertical reinforcing fin are integrally formed, thus enhancing production efficiency.

9. The cryogenic valve as set forth in claim 3, wherein the bonnet has on a circumferential outer surface thereof a vertical reinforcing fin extending in a longitudinal direction of the bonnet, so that a thickness of the bonnet is reducible, and the bonnet and the vertical reinforcing fin are integrally formed, thus enhancing production efficiency.
